(19) United States
(12) Patent Application Publication
(10) Pub. No.: US 2016/0153347 A1
(43) Pub. Date: Jun. 2, 2016

(54) AIR-INTAKE SYSTEM FOR INTERNAL COMBUSTION ENGINE

(71) Applicant: TOYOTA JIDOSHA KABUSHIKI KAISHA, Toyota-shi (JP)

(72) Inventors: Shuichi MORIE, Toyota-shi (JP); Yoshiki HIRAI, Toyota-shi (JP)

(21) Appl. No.: 14/934,523

(22) Filed: Nov. 6, 2015

(30) Foreign Application Priority Data
Nov. 28, 2014 (JP) 2014-241363

(51) Int. Cl. F02B 29/04; F02M 35/10

(52) U.S. Cl. CPC F02B 29/0418; F02M 35/10019; F02M 35/10144; F02M 35/1038

(57) ABSTRACT

An air-intake system for internal combustion engine is provided. The air-intake system includes a inter cooler and a bypass passage that bypasses the inter cooler by connecting a first air passage and a second intake air passage, which are on an upstream side and a downstream side of the inter cooler respectively. A mounting seat for an intake air temperature sensor is arranged on a confluence part of the second intake air passage and the bypass passage. Positions of the mounting seat and the bypass passage in an axis direction of the second intake air passage are at least partially overlaping.

### INCORPORATION BY REFERENCE

The disclosure of Japanese Patent Application No. 2014-241363 filed on Nov. 28, 2014 including the specification, drawings and abstract is incorporated herein by reference in its entirety.

### BACKGROUND OF THE INVENTION

1. Field of the Invention

The invention belongs to a technical field of a structure suitable for a case where a passage bypassing an inter cooler is provided in an air-intake system for an internal combustion engine having a supercharger.

2. Description of Related Art

Conventionally, in an internal combustion engine having a supercharger, which is installed in a vehicle such as an automobile, there are instances where an inter cooler is provided for cooling intake air at high temperature compressed by a compressor and so on. In general, an inter cooler is structured so as to take heat of intake air by using traveling wind. Therefore, in an extreme cold environment where outside air temperature is below freezing point, super cooling could happen. Also, moisture contained in intake air freezes inside the inter cooler, and thus could block a part of an intake air passage.

Therefore, in an internal combustion engine of a vehicle described in Japanese Patent Application Publication No. 2002-147243 (JP 2002-147243 A), a bypass passage is provided, which makes a detour around an inter cooler (referred to as an after cooler in the document). The bypass passage is made by inserting two joining members between two bypass members on an entrance side and an exit side of the inter cooler, and a valve is arranged between the two joining members to open and close the bypass passage.

In the intake air passage on the upstream side of the inter cooler, a sensor is arranged in the vicinity of a branch part of the bypass passage. Also, in the intake air passage on the downstream side in the inter cooler, a sensor is arranged in the vicinity of a confluence part of the bypass passage. The sensor in the vicinity of the confluence part includes, for example, an intake air temperature sensor.

In the confluence part of the bypass passage in the intake air passage, a flow of intake air at relatively low temperature from the inter cooler joins a flow of intake air at relatively high temperature from the bypass passage, and intake air at different temperatures is mixed together. Conventionally, an intake air temperature sensor is generally arranged on the downstream side of the confluence part at an interval so as to detect temperature after intake air is mixed together as stated above.

### SUMMARY OF THE INVENTION

However, in order to arrange an intake air temperature sensor on a downstream side of a confluence part of a bypass passage as stated above, a mounting seat for the intake air temperature sensor and the confluence part of the bypass passage have to be provided in a rigid resin duct that structures an intake air passage, so that the mounting seat for the intake air temperature sensor and the confluence part of the bypass passage are separated from each other in the longitudinal direction of the duct. As a result, the duct becomes long. This means that a space for arranging the mounting seat for the intake air temperature sensor and the confluence part of the bypass passage becomes large in a direction in which the intake air passage extends.

In the case where a confluence part of a bypass passage and a mounting seat for an intake air temperature sensor are provided in an intake air passage on a downstream side in an inter cooler, the invention is able to reduce a space for arranging the confluence part of the bypass passage and the mounting seat for the intake air temperature sensor.

According to one viewpoint of the present invention, an air-intake system for internal combustion engine is provided. The air-intake system including an inter cooler, a first intake air passage, a second intake air passage, a bypass passage, and a mounting seat for an intake air temperature sensor. The first intake air passage is arranged on an upstream side of the inter cooler, and the second intake air passage is arranged on a downstream side of the inter cooler. The bypass passage makes a detour around the inter cooler by connecting the first intake air passage and the second intake air passage with each other. The mounting seat for an intake air temperature sensor is arranged on a confluence part of the second intake air passage and the bypass passage. The position of the mounting seat in an axis direction of the second intake air passage is at least partially overlaping a position of the bypass passage in the axis direction of the second intake air passage.

As stated above, the mounting seat for the intake air temperature sensor and the confluence part of the bypass passage are arranged so as to at least partially overlap each other in the intake air passage on the downstream side in the inter cooler. Thus, compared to a case where the mounting seat for the intake air temperature sensor and the confluence part of the bypass passage are separated from each other, it is possible to reduce a space necessary for arranging the mounting seat for the intake air temperature sensor and the confluence part of the bypass passage in a direction in which the intake air passage extends.

Further, in the air-intake system stated above, a cylindrical part provided in the confluence part may project outwardly from the second intake air passage, and be thus fitted into a downstream end part of the bypass passage. An external dimension of the cylindrical part may be set to be equal to or smaller than an external dimension of the mounting seat. This way, it is possible to arrange the cylindrical part so as to be included in the mounting seat in the direction in which the intake air passage extends, thereby minimizing the space for arranging the cylindrical part and the mounting seat to a size of the mounting seat.

However, as stated above, temperature of intake air joining from the bypass passage is higher than that of intake air cooled by the inter cooler. When the mounting seat for the intake air temperature sensor and the confluence part of the bypass passage are arranged so as to overlap each other like the above-mentioned structure, the intake air temperature sensor detects temperature of intake air before being mixed sufficiently. Therefore, detected temperature could be shifted to a low-temperature side or a high-temperature side from intake air temperature after intake air is sufficiently mixed.

In this case, when the detected intake air temperature is shifted to the low-temperature side, a relatively large amount of intake air filled in a combustion chamber is calculated. Therefore, a fuel injection amount controlled accordingly becomes larger, thereby causing a shift of an air-fuel ratio to a rich side from a theoretical air-fuel ratio. This causes an increase in a HC density in exhaust gas, and there is thus a concern of deterioration of reliability of an exhaust system, a catalyst, and so on.

Further, in the air-intake system, a central line of an end part of the cylindrical part may coincide with an axis of the mounting seat. This way, an influence of intake air at relatively high temperature from the bypass passage becomes greater, thereby preventing intake air temperature detected by the intake air temperature sensor from shifting to the low-temperature side.

Further, in the air-intake system, the cylindrical part may project to an inner side of the second intake air passage, and the end part of the cylindrical part on the inner side of the second intake air passage may be positioned on the intake air temperature sensor side beyond the axis of the second intake air passage. This way, a flow of intake air joining from the bypass passage is blown on the intake air temperature sensor more strongly, thereby preventing detected intake air temperature from shifting to the low-temperature side.

In the foregoing air-intake system, when an external dimension of the cylindrical part fitted into the downstream end part of the bypass passage is set to a small dimension, a sectional area of the passage inside the cylindrical part also becomes small. Therefore, a plurality of bypass passages may be provided in parallel to each other in order to ensure a required flow rate of intake air in the bypass passage.

Further, in the air-intake system, both the cylindrical part and the mounting seat may be positioned on an upper half side of a transverse section of the second intake air passage. The expression “to be present in the upper half part” means that it is only necessary that the cylindrical part and the mounting seat are at least partially positioned in the upper half part of the intake air passage, and the remaining parts may be positioned in a lower half part of the intake air passage. In other words, neither the cylindrical part nor the mounting seat is arranged in a lower part of the intake air passage.

This is because condensed water and so on contained in intake air cooled inside the inter cooler could stagnate in the intake air passage on the downstream side. Unless the mounting seat is provided in the lower part of intake air passage, it is possible to prevent detection failure of the intake air temperature sensor caused by stagnated condensed water and so on. When the stagnated condensed water and so on freezes, the frozen condensed water is melted by blowing a flow of intake air at relatively high temperature from the bypass passage above.

According to another viewpoint of the present invention, an air-intake system for internal combustion engine is provided. The air-intake system including an inter cooler, a first intake air passage, a second intake air passage, a bypass passage, and a mounting seat for an intake air temperature sensor. The first intake air passage is arranged on an upstream side of the inter cooler, and the second intake air passage is arranged on a downstream side of the inter cooler. The bypass passage makes a detour around the inter cooler by connecting the first intake air passage and the second intake air passage with each other. The mounting seat is provided in the second intake air passage, and arranged on a same circumference of the second intake air passage with the cylindrical part in the second intake air passage.

Further, in the air-intake system, the cylindrical part may project outwardly from the second intake air passage, and be configured to be fitted into a downstream end part of the bypass passage. An external dimension of the cylindrical part may be set to be equal to or smaller than an external dimension of the mounting seat.

Further, in the air-intake system, a central line of an end part of the cylindrical part may be arranged so as to coincide with an axis of the mounting seat.

Further, in the air-intake system, the cylindrical part may project to an inner side of the second intake air passage. The end part of the cylindrical part on the inner side of the second intake air passage may be positioned on the intake air temperature sensor side beyond an axis of the second intake air passage. The end part of the cylindrical part on the inner side of the second intake air passage may face the intake air temperature sensor at a given interval.

Further, in the air-intake system, a plurality of bypass passages may be provided in parallel to each other.

Further, in the air-intake system, both the cylindrical part and the mounting seat may be positioned on an upper half side of the second intake air passage.

According to the air-intake system for the internal combustion engine of the invention, the confluence part of the bypass passage that makes a detour around the inter cooler is arranged so as to at least partially overlap the mounting seat for the intake air temperature sensor in the direction in which the intake air passage on the downstream side extends. Therefore, compared to a case where the confluence part and the mounting seat are separated from each other, it is possible to reduce a space required for arranging the confluence part and the mounting seat in the direction in which the intake air passage extends.

### BRIEF DESCRIPTION OF THE DRAWINGS

Features, advantages, and technical and industrial significance of exemplary embodiments of the invention will be described below with reference to the accompanying drawings, in which like numerals denote like elements, and wherein:

FIG. 1 is a schematic view roughly showing an air-intake system and an exhaust system of an internal combustion engine according to the invention;

FIG. 2 is a perspective view of an inter cooler from behind and slightly diagonally above;

FIG. 3 is an exploded and enlarged perspective view showing a duct, a connecting member, and a rubber hose;

FIG. 4 is a transverse sectional view (a sectional view taken along the line IV-IV in FIG. 3) of the connecting member showing a mutual positional relationship between a large cylindrical part, which extends into an intake air passage, and an intake air temperature sensor;

FIG. 5 is a graph charts of experiment results for investigating variation of intake air temperature detected at different positions of the intake air temperature sensor; and

FIG. 6 corresponds to FIG. 2 and is a view according to another embodiment in which a confluence part of a bypass passage and a mounting seat for the intake air temperature sensor are provided in a duct of the intake air passage on the downstream side.

### DETAILED DESCRIPTION OF EMBODIMENTS

An embodiment of the invention is explained based on the drawings. In this embodiment, a case is explained where the invention is applied to a gasoline engine 1 (an internal combustion engine) having a turbosupercharger equipped in a vehicle.

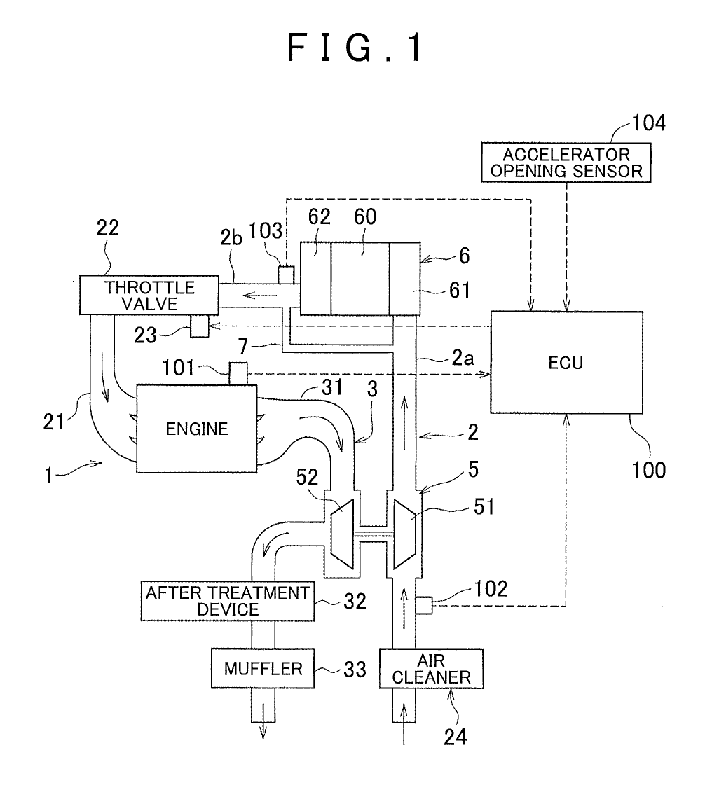

FIG. 1 schematically shows an intake and exhaust system of an engine 1, and so on. In the engine 1, which is a gasoline engine as an example, although not shown, a piston is housed in each of a plurality of cylinders, and reciprocation of the piston is converted into rotation of a crankshaft by a connecting rod. In order to calculate speed of rotation of the crankshaft, or engine speed, a publicly known crank position sensor 101 is provided.

Further, an intake air passage 2 for drawing air into a combustion chamber of each of the cylinders, and an exhaust passage 3 for discharging burned gas from the combustion chamber are provided. A lowermost stream part of an intake air flow in the intake air passage 2 is an intake manifold 21 that branches out for the respective cylinders, and is communicated with the combustion chambers through intake ports (not shown) formed in the cylinder head of the engine 1. Meanwhile, a throttle valve 22 for squeezing an intake air flow is arranged on an upstream side in the intake air flow compared to the intake manifold 21, and opening of the throttle valve 22 is adjusted by an electric motor 23.

In the intake air passage 2, an air cleaner 24 for filtrating intake air, an air flow meter 102 for detecting a flow rate of intake air, and a compressor 51 of the turbosupercharger 5 are arranged in this order from the upstream side of the intake air flow. On a downstream side of the intake air flow after the compressor 51, an inter cooler 6 is arranged for cooling intake air that has been compressed and temperature is increased. The inter cooler 6 is of a cross flow type, and has side tanks 61, 62 on the left and right sides, sandwiching a core 60 through which traveling wind passes.

A downstream end part of the intake air passage 2a on the upstream side, which extends from the compressor 51 of the turbosupercharger 5, is connected with the side tank 61 on an entrance side (the right side in FIG. 1) of the inter cooler 6. Meanwhile, an upstream end part of the intake air passage 2b on the downstream side, which extends towards the throttle valve 22, is connected with the side tank 62 on an exit side (the left side in FIG. 1) of the inter cooler 6. Further, a bypass passage 7 is provided from the intake air passage 2a on the upstream side to the intake air passage 2b on the downstream side so that the bypass passage 7 makes a detour around the inter cooler 6.

Although the details are given later, an intake air temperature sensor 103 is arranged in an area where the bypass passage 7 joins the intake air passage 2b on the downstream side. The intake air temperature sensor 103 detects temperature of intake air and sends a signal to an ECU 100. In this embodiment, the intake air temperature sensor 103 detects temperature of intake air before a flow of intake air at relatively low temperature, which is cooled by the inter cooler 6, and a flow of air at relatively high temperature, which has gone through the bypass passage 7, are mixed together sufficiently.

Although not shown, an injector for port injection is arranged in each of the cylinders of the engine 1 so that the injector for port injection faces an intake port and injects fuel. Fuel injected by the injector for port injection is mixed with intake air going through the intake air passage 2, and then supplied into the combustion chamber inside the cylinder. An injector for injection into a cylinder may also be provided so as to face the combustion chamber inside the cylinder and inject fuel directly into the combustion chamber.

Meanwhile, an uppermost stream part of an exhaust gas flow in the exhaust passage 3 is an exhaust manifold 31 that branches out for each of the cylinders. On a downstream side of the exhaust manifold 31, a turbine 52 of the turbosupercharger 5, an after treatment device 32 for exhaust gas, such as a three-way catalyst, and a muffler 33 for reducing a volume of sound of the exhaust gas are arranged in this order. In the turbosupercharger 5, as the turbine 52 receives an exhaust gas flow and rotates, the compressor 51 rotates in a forward direction integrally with the turbine 52, and intake air is compressed and sent into the cylinder.

Although not shown, the ECU 100 includes a CPU (central processing unit), a ROM (read only memory), a RAM (random access memory), a backup RAM and so on. The CPU carries out various operation processing based on various control programs and maps stored in the ROM. The RAM temporally stores results of operations in the CPU, data and so on inputted from each of the sensors, and the backup RAM stores the data and so on to be stored when, for example, the engine 1 is stopped.

Other than the aforementioned crank position sensor 101, the air flow meter 102, the intake air temperature sensor 103 and so on, an accelerator opening sensor 104 is also connected with the ECU 100. The accelerator opening sensor 104 detects an operation amount of an accelerator pedal (accelerator opening) by an occupant of the vehicle. Although not shown, an intake air pressure sensor, an air-fuel ratio sensor, an 02 sensor, and so on are also connected with the ECU 100.

The ECU 100 is structured to control an operation of the engine 1 by carrying out various control programs based on signals from the foregoing various sensors. For example, the ECU 100 calculates a target load factor of the engine 1 based on accelerator opening detected by the accelerator opening sensor 104, and engine speed calculated based on signals from the crank position sensor 101, and then controls throttle opening accordingly.

The ECU 100 also calculates an amount of intake air filled in the cylinder, or an actual load factor, based on a flow rate of intake air detected by the air flow meter 102 and engine speed, and controls a fuel injection amount accordingly. At this time, the actual load factor is corrected in accordance with intake air temperature detected by the intake air temperature sensor 103. This means that, the higher the intake air temperature is, the lower the actual load factor becomes, and a fuel injection amount is thus reduced. Also, the lower the intake air temperature is, the higher the actual load factor becomes, and the fuel injection amount is thus increased.

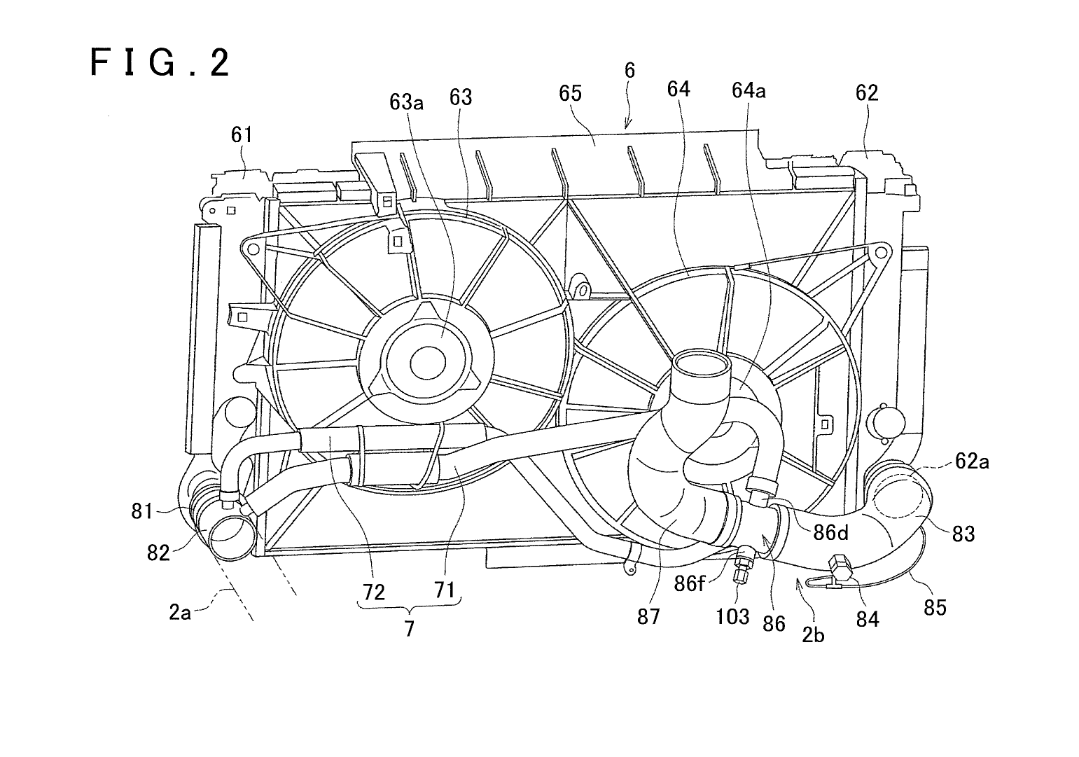

Next, structures of the inter cooler 6 and the bypass passage 7 are explained in detail. As shown in FIG. 2 from the rear of a vehicle body and from slightly diagonally above, the inter cooler 6 is arranged in, for example, an engine compartment in a front part of the vehicle body, and the engine 1 (not shown in FIG. 2) is mounted behind the inter cooler 6 horizontally so that the crankshaft is arranged along the vehicle width direction. The downstream end part of the intake air passage 2a on the upstream side (shown by a virtual line) is connected with a lower part of the side tank 61 on the entrance side, which is positioned on the left side of the vehicle body. Thus, the lower part of the side tank 61 receives intake air at high temperature that is pressurized and sent from the turbosupercharger 5 (the compressor 51).

The intake air passage 2a on the upstream side is structured mainly by a resin duct, and a rubber hose 81 is provided in a connecting part with the side tank 61 in order to absorb relative displacement between the inter cooler 6 and the engine 1. This means that a boss part (not shown), which projects to the rear, is provided integrally with the lower part of the side tank 61, and a front end part of the rubber hose 81 is attached to the boss part. Meanwhile, a front end part of a cylindrical connecting member 82 is fitted into a rear end part of the rubber hose 81, and a rear end part of the connecting member 82 is fitted into a front end part of the resin duct (not shown) that is a part of the intake air passage 2a on the upstream side.

This means that the intake air passage 2a on the upstream side is connected with the boss part of the side tank 61, which is an entrance of the inter cooler 6, through the rubber hose 81 and the connecting member 82 on the entrance side. Although detailed explanation is omitted, the connecting member 82 is made from an iron pipe like a later-described connecting member 86 on the exit side, and two cylindrical parts, which are a large cylindrical part and a small cylindrical part, to be fitted into upstream end parts of the bypass hoses 71, 72 (the bypass passage), respectively, are provided so as to be separated from each other on an outer periphery of the connecting member 82.

Then, heat of the intake air at high temperature, which is flown into the side tank 61 on the entrance side from the intake air passage 2a on the upstream side, is taken by wind that passes through the core 60 (see FIG. 1) while the intake air flows in a passage inside the core 60 and reaches the side tank 62 on the exit side. Thus the intake air is cooled. As shown in FIG. 2, two cooling fans 63, 64 are attached on a rear surface of the core 60, and are rotated by electric motors 63a, 64a, respectively. Support members for the two cooling fans 63, 64 are provided integrally with a resin shroud 65 that covers the whole rear surface of the core 60.

The intake air that has been cooled as stated above is flown out to the intake air passage 2b on the downstream side from the side tank 62 on the exit side. This means that, as shown in FIG. 2, a boss part 62a (shown by a broken line) projecting to the rear is provided integrally with a lower part of the side tank 62, and a resin duct 83, which is a part of the intake air passage 2b on the downstream side, is attached to the boss part 62a. After slightly extending to the rear from the boss part 62a, the duct 83 curves slightly downwardly while also curving to the left side, and then gradually turns upwardly while extending to the left side, thereby forming a gentle U shape.

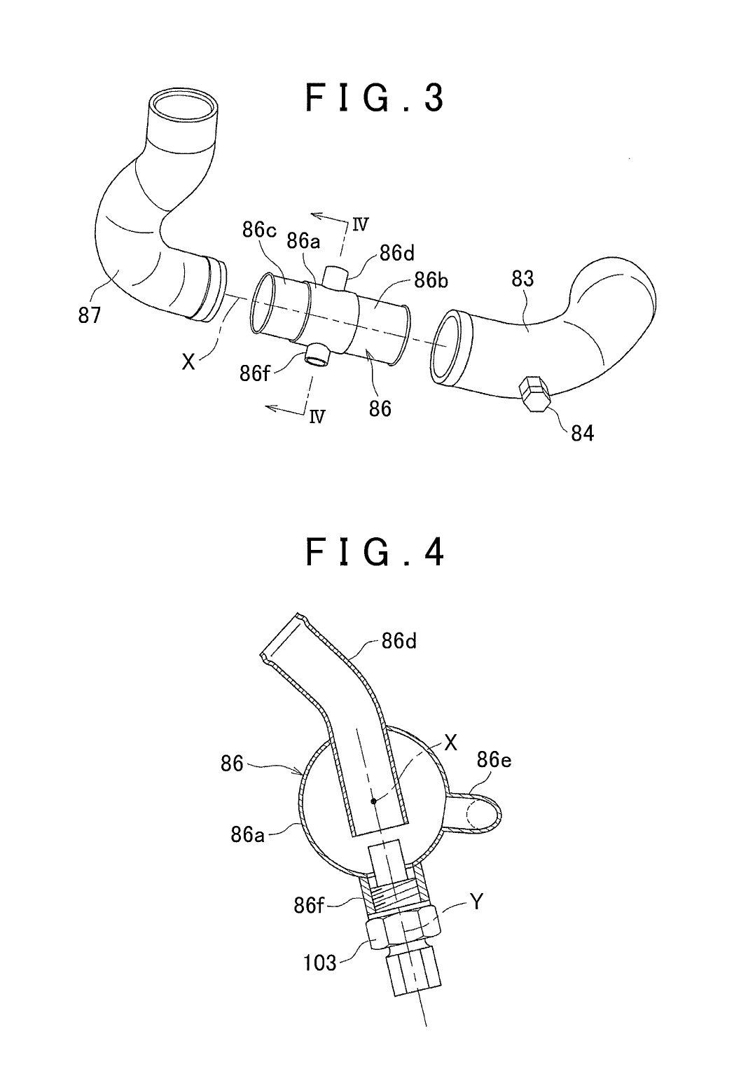

In an intermediate part of the duct 83, which corresponds to a lowermost part of the U shape, condensed water and so on contained in the intake air that is cooled inside the inter cooler 6 could stagnate, and a plug 84 is provided in order to discharge the condensed water and so on. A hose 85 for drawing out water and so on by using negative pressure is connected with the plug 84. As shown in the enlarged view in FIG. 3, one end part (a right end part in FIG. 2 and FIG. 3) of the cylindrical connecting member 86 is fitted into a distal end part (a downstream end part) of the duct 83 extending towards the left side as stated above.

The connecting member 86 on the exit side is also made from an iron pipe, and, as shown in FIG. 3, a body part 86a, and diameter-reduced parts 86b, 86c are provided. The diameter-reduced parts 86b, 86c are provided respectively in one end side and the other end side (the left side in FIG. 2 and FIG. 3) of the body part 86a in a direction of a cylinder axis X of the connecting member 86. While the diameter-reduced part 86b on one end side is fitted into a distal end part of the duct 83, an upstream end part (a right end part in FIG. 3) of a rubber hose 87, which is a part of the intake air passage 2b on the downstream side, is attached to the diameter-reduced part 86c on the other end side of the connecting member 86.

This means that the intake air passage 2b on the downstream side is structured from the duct 83, the connecting member 86, and the rubber hose 87 described above, and the downstream end part (an upper end part in FIG. 3) of the rubber hose 87 is connected with the throttle valve 22. Thus, intake air cooled in the inter cooler 6 flows in the duct 83, the connecting member 86, and the rubber hose 87, reaches the throttle valve 22, and is distributed to each of the cylinders of the engine 1 from the intake manifold 21.

As shown in the transverse section (the section perpendicular to the cylinder axis X) in FIG. 4, two cylindrical parts, which are a large cylindrical part 86d and a small cylindrical part 86e and respectively fitted into downstream end parts of the bypass hoses 71, 72, are provided in an outer periphery of the connecting member 86 so that the cylindrical parts are separated from each other in a circumferential direction. This means that upstream end parts of the two rubber bypass hoses 71, 72 are attached to the cylindrical parts on the outer periphery of the connecting member 82 on the entrance side, respectively, and branch out from the intake air passage 2a on the upstream side. Meanwhile, downstream end parts of the bypass hoses 71, 72 are attached to the large cylindrical part 86d and the small cylindrical part 86e on the outer periphery of the connecting member 86 on the exit side, respectively, and join the intake air passage 2b on the downstream.

In this embodiment, the bypass passage 7 is thus structured from the two rubber bypass hoses 71, 72 (a plurality of bypass passages parallel to each other) that are provided in parallel to each other from the intake air passage 2a on the upstream side to the intake air passage 2b on the downstream side. Confluence parts (the large cylindrical part 86d, the small cylindrical part 86e) of the bypass hoses 71, 72 to the intake air passage 2b on the downstream side are provided in the connecting member 86.

The bypass passage 7 (the bypass hoses 71, 72) in this embodiment is not provided with a valve that opens and closes the bypass passage 7 and adjusts a flow rate of intake air, thereby reducing component cost, and development cost for control programs that cause the valve to operate appropriately. In this case, since intake air always flows in the bypass passage 7, a small sectional area of the bypass passage 7 is preferred in terms of cooling of intake air by using the inter cooler 6.

On the other hand, in an extreme cold environment, there are instances where moisture contained in intake air freezes inside the inter cooler 6, and blocks the passage of intake air inside the core 60. This causes most of intake air to flow in the bypass passage 7. Therefore, in order to ensure an engine output to some extent in this condition, it is required to ensure a sectional area of the bypass passage 7 to some extent or more.

Thus, a minimum value of the sectional area of the bypass passage 7 is set so as to ensure a minimum amount of intake air required to obtain an engine output at a degree that enables evacuation travel of a vehicle, and to have an intake air flow amount to a degree that does not cause negative pressure in the intake manifold 21 at the time of evacuation travel. This is because a control system of the engine 1 having a supercharger is structured on the assumption that pressure in the intake manifold 21 does not become negative.

Then, thicknesses of the bypass hoses 71, 72 are set so that the sum of the sectional areas of intake air passages in the two bypass hoses 71, 72 becomes the minimum value of the sectional area or larger. In this embodiment, the bypass hose 71 is thicker than bypass hose 72, and the sectional area of the intake air passage of the bypass hose 71 is larger. An outer diameter of the large cylindrical part 86d, which is fitted into the downstream end part of the thicker bypass hose 71, is larger than that of the small cylindrical part 86e that is fitted into the downstream end part of the bypass hose 72.

As shown in FIG. 4 described above, the large cylindrical part 86d extends slightly diagonally after extending upwardly from an upper part of the connecting member 86. Meanwhile, the small cylindrical part 86e projects to the front from an area of the outer periphery of the connecting member 86 on the front side of the vehicle body, and is then bent to the left side after slightly extending to the front. In the example shown in the drawings, the outer diameter of the small cylindrical part 86e is about two third of the outer diameter of the large cylindrical part 86d.

As shown in FIG. 3 and FIG. 4, a mounting seat 86f for the intake air temperature sensor 103 is also provided in the connecting member 86. The mounting seat 86f is provided as a round seat projecting downwardly from a lower part of the outer periphery of the connecting member 86, and an internal thread is formed in an inner peripheral surface of a through hole that opens in a seat surface of the mounting seat 86f. A part of the intake air temperature sensor 103 on a distal end side is inserted into the through hole, and an external thread formed on an outer peripheral surface of the part of the intake air temperature sensor 103 on the distal end side is screwed to the internal thread of the through hole.

As shown in the same transverse section in FIG. 4, the connecting member 86 is provided with the large cylindrical part 86d and the small cylindrical part 86e by which the bypass hoses 71, 72 are joined, and the mounting seat 86f for the intake air temperature sensor. The mounting seat 86f faces the large cylindrical part 86d along the vertical direction, and a central line Y of the mounting seat 86f and a cylinder axis of an end part of the large cylindrical part 86d coincide with each other. In this embodiment, the outer diameter of the large cylindrical part 86d is set to be generally the same as (or slightly smaller than) that of the mounting seat 86f, and the large cylindrical part 86d is included in the mounting seat 86f when seen along the central line Y of the mounting seat 86f.

In other words, the large cylindrical part 86d is arranged so as to entirely overlap the mounting seat 86f for the intake air temperature sensor 103 in the direction of the cylinder axis X (a direction in which the intake air passage 2b on the downstream side extends) of the connecting member 86 made from an iron pipe. This means that the mounting seat 86f and the large cylindrical part 86d are arranged on the same circumference in the intake air passage 2b. Similarly, the small cylindrical part 86e having a diameter smaller than that of the large cylindrical part 86d is also arranged so as to entirely overlap the mounting seat 86f in the direction of the cylinder axis X of the connecting member 86. This means that the small cylindrical part 86e and the mounting seat 86f are also arranged on the same circumference in the intake air passage 2b.

In this embodiment, a space required for providing the confluence parts (the large cylindrical part 86d, the small cylindrical part 86e) of the bypass hoses 71, 72 is minimized to the outer diameter of the mounting seat 86f in the direction in which the intake air passage 2b on the downstream side extends, and it is thus possible to sufficiently increase the length of the rubber hose 87 accordingly.

Temperature of intake air, which joins from the bypass hoses 71, 72 through the large cylindrical part 86d and the small cylindrical part 86e, is higher than that of intake air cooled in the inter cooler 6. As stated earlier, when the large cylindrical part 86d and the small cylindrical part 86e are arranged so as to be included in the mounting seat 86f for the intake air temperature sensor 103, the intake air temperature sensor 103 detects temperature of intake air before intake air at different temperatures is mixed together sufficiently.

Then, as described earlier, an actual load factor is corrected in the ECU 100 in accordance with detected intake air temperature. When intake air temperature is low, the actual load factor calculated becomes high, and a fuel injection amount is increased accordingly. If intake air temperature detected by the intake air temperature sensor 103 is shifted to a low-temperature side from intake air temperature after intake air is mixed sufficiently, a fuel injection amount becomes large relative to an amount of intake air filled in the cylinder, and an air-fuel ratio is shifted to a rich side. This causes a high HC density in exhaust gas, and there is thus a concern over deterioration of reliability of the turbine 52 and the after treatment device 32 of the exhaust system.

Accordingly, in this embodiment, the large cylindrical part 86d is arranged so as to face the mounting seat 86f for the intake air temperature sensor 103 as described earlier, so that a flow of intake air flowing from the thicker bypass hose 71 is blown on the intake air temperature sensor 103. Further, as shown in FIG. 4, the large cylindrical part 86d extends inside the connecting member 86 (inside the intake air passage 2b on the downstream side), and the extending end part is positioned on the intake air temperature sensor 103 side beyond the cylinder axis X of the connecting member 86 (an axis of the intake air passage 2b on the downstream side). Thus, an influence of intake air at relatively high temperature from the bypass hose 71 becomes greater, thereby preventing intake air temperature detected by the intake air temperature sensor 103 from shifting to the low-temperature side.

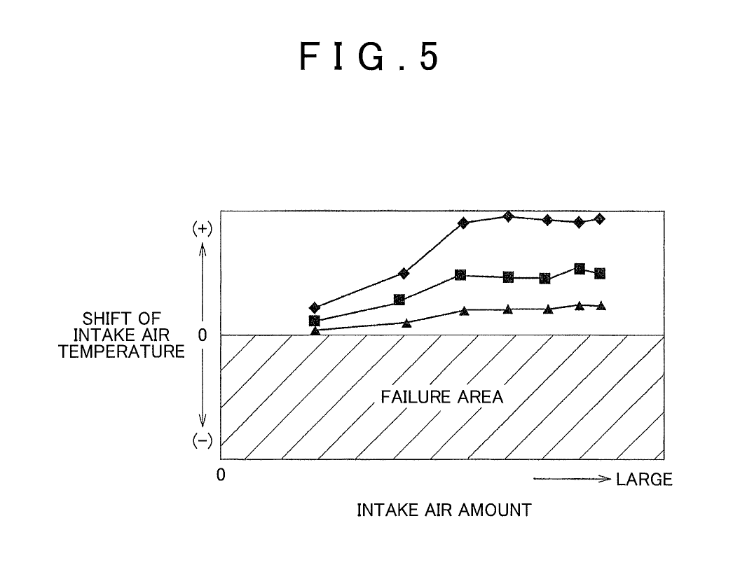

FIG. 5 shows results of an experiment in which variation of intake air temperature is investigated when the position of the intake air temperature sensor 103 is changed by placing a shim between the intake air temperature sensor 103 and the seat surface of the mounting seat 86f. The horizontal axis of the graph represents an intake air amount of the engine 1, and is a flow rate of intake air detected by the air flow meter 102. The vertical axis represents a shift of intake air temperature detected by the intake air temperature sensor 103 from actual intake air temperature (temperature of intake air after intake air is sufficiently mixed).

Seeing the three graphs shown in FIG. 5, it is understood that the shifts of intake air temperature increase for a while as the flow rate increases from a state of, for example idling, when a flow rate of intake air is low, and then the shifts become generally constant after the flow rate reaches a certain level or higher. In a state where the intake air temperature sensor 103 is positioned closest to the large cylindrical part 86d, the shift becomes the largest as shown in the first graph on the top (♦). When the intake air temperature sensor 103 is distanced from the seat surface by placing a 1 mm-thick shim between the seat surface and the intake air temperature sensor 103, the shift is reduced by half as shown in the second graph (▪). When a 2 mm-thick shim is placed between the seat surface and the intake air temperature sensor 103, the shift is reduced further by half as shown in the third graph (▴).

As stated so far, as the large cylindrical part 86d and the intake air temperature sensor 103 become closer to each other, detected intake air temperature becomes higher, and, as the large cylindrical part 86d and the intake air temperature sensor 103 are separated from each other, the detected intake air temperature becomes lower. However, in any of the three graphs, shifts of the detected intake air temperature are positive values. The shifts do not become negative values and thus do not fall within a reliability failure area. Therefore, by setting an interval between (interval between end parts of) the large cylindrical part 86d and the intake air temperature sensor 103 on the basis of the position of the second graph (▪) in FIG. 5, it becomes possible to prevent detected intake air temperature from shifting to the low-temperature side even when the position of the intake air temperature sensor 103 is changed to the front or back by 1 mm or so due to machining accuracy of the seat surface of the mounting seat 86f or adhesion of foreign substance on the seat surface.

As explained above, in the air-intake system for the engine 1 according to this embodiment, the intake air passage 2b on the downstream side of the inter cooler 6 is structured from the duct 83, the connecting member 86, and the rubber hose 87, and the confluence parts (the large cylindrical part 86d, the small cylindrical part 86e) of the bypass passage 7 (the bypass hoses 71, 72) are provided in the connecting member 86 together with the mounting seat 86f for the intake air temperature sensor 103. Then, the confluence parts (the large cylindrical part 86d, the small cylindrical part 86e) are arranged so as to entirely overlap the mounting seat 86f in the direction of the cylinder axis X of the connecting member 86. In other words, in the connecting member 86, the large cylindrical part 86d, the small cylindrical part 86e, and the mounting seat 86f are arranged on the same circumference.

With this structure, a space for arranging the confluence parts (the large cylindrical part 86d, the small cylindrical part 86e) of the bypass passage 7 and the mounting seat 86f for the intake air temperature sensor 103 is minimized to the size of the mounting seat 86f in the direction in which the intake air passage 2b on the downstream side extends, and the rubber hose 87 is extended accordingly. Thus, it is possible to sufficiently obtain the function of absorbing relative displacement between the inter cooler 6 and the engine 1 using elastic deformation of the rubber hose 87.

In this embodiment, in order to make the confluence parts (the large cylindrical part 86d, the small cylindrical part 86e) of the bypass passage 7 included in the mounting seat 86f in the direction of the cylinder axis X of the connecting member 86, the bypass passage 7 is structured from the two bypass hoses 71, 72 with different thicknesses from each other, and the outer diameter of the large cylindrical part 86d, which is the confluence part of the thicker bypass hose 71, is set to be generally the same as that of the mounting seat 86f of the intake air temperature sensor 103. Therefore, the total sectional area of the passages in the two bypass hoses 71, 72 becomes a previously set minimum value or larger. Thus, even when most of intake air flows in the bypass hoses 71, 72 due to blockage of the inter cooler 6 and so on, it is possible to stably ensure an engine output to a degree that makes evacuation travel possible.

Descriptions of the embodiments explained above are examples only, and are not intended to limit structure and usage of the invention. For example, in the foregoing embodiment, the bypass passage 7 is structured from the two bypass hoses 71, 72 that are in parallel to each other. However, the invention is not limited to this, and the bypass passage 7 may be structured from, for example, one bypass hose, or three bypass hoses or more.

In the foregoing embodiment, the confluence parts (the large cylindrical part 86d, the small cylindrical part 86e) of the bypass hoses 71, 72 are arranged so as to entirely overlap the mounting seat 86f for the intake air temperature sensor 103 in the direction of the cylinder axis X of the connecting member 86. However, the invention is not limited to this, and the confluence parts may be provided so as to partially overlap the mounting seat in the direction of the cylinder axis X of the connecting member 86. This means that the large cylindrical part 86d, the small cylindrical part 86e, and the mounting seat 86f may be provided on the same circumference in the connecting member 86. In such a case, it is preferred that the confluence parts are moved to the upstream side of an intake air flow, so that intake air at different temperatures is mixed together as much as possible before being blown on the intake air temperature sensor 103. Further, the external dimensions of the large cylindrical part 86d and the small cylindrical part 86e may be set to be generally the same or slightly smaller than that of the mounting seat 86f.

In the foregoing embodiment, the connecting members 82, 86 made from iron pipes are used on the entrance side and the exit side of the inter cooler 6, respectively. However, the invention is not limited to this, and, for example, branch parts and confluence parts of the bypass passage 7, and the mounting seat for the intake air temperature sensor 103 may be provided in connecting parts that are provided integrally with the side tanks 61, 62 of the inter cooler 6.

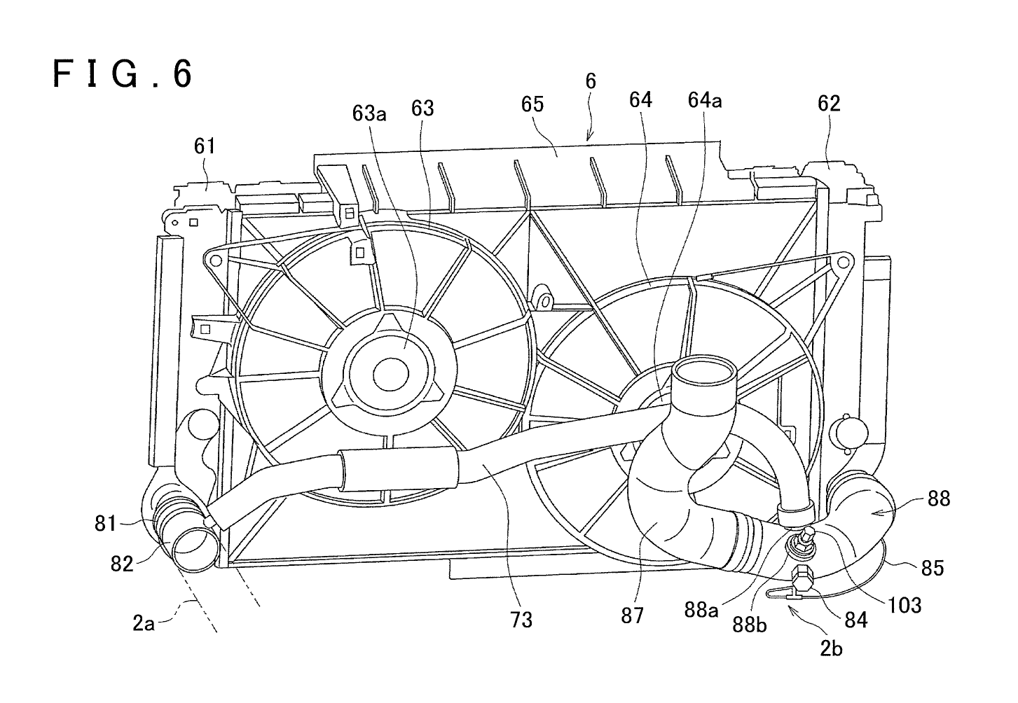

As in an example shown in FIG. 6, a confluence part (a cylindrical part 88a) of a bypass passage 7, and a mounting seat 88b for an intake air temperature sensor 103 may be provided in a resin duct 88 (corresponding to the duct 83 in the foregoing embodiment) provided on an exit side of an inter cooler 6. This means that the duct 88 forms a gentle U shape similarly to the duct 83 of the foregoing embodiment, and a plug 84 is provided in a lower part of the duct 88, which corresponds to the lowermost part of the U shape.

The above-mentioned cylindrical part 88a and the mounting seat 88b are provided so as be present on the same transverse section of the duct 88 as the plug 84. The cylindrical part 88a projects upwardly from an upper part of the duct 88, and is fitted into a downstream end part of one bypass hose 73 that structures the bypass passage 7. The mounting seat 88b is provided as a round seat projecting to the rear from the rear side of the outer periphery of the duct 88. This means that the cylindrical part 88a and the mounting seat 88b are positioned in an upper half part of the duct 88 at least partially.

In other words, the cylindrical part 88a and the mounting seat 88b are provided so as to be present in the upper half part of the transverse section of the duct 88, and are not positioned in the lower part of the duct 88 where condensed water and so on stagnates. Therefore, there is no concern for detection failure of the intake air temperature sensor 103 due to condensed water and so on. In addition, when stagnated condensed water and so on freezes, intake air at relatively high temperature joining from the bypass hose 73 through the cylindrical part 88a above is able to melt the frozen condensed water.

Furthermore, in the foregoing embodiment, a case was explained as an example where the invention is applied to the gasoline engine 1 having the turbosupercharger 5. However, the invention is not limited to this, and may be applicable to, for example, a gasoline engine, a gas engine, and a diesel engine having a mechanical supercharger or an electric supercharger. The invention is also applicable to an engine of a hybrid vehicle in which an electric motor is mounted other than the engine as a drive power source.

According to the invention, in the air-intake system for the internal combustion engine, it is possible to reduce a space that is necessary for arranging a confluence part of a bypass passage and a mounting seat for an intake air temperature sensor on a downstream side of an inter cooler. Therefore, the invention is highly effective when the invention is applied to, for example, an engine mounted on a passenger car.

What is claimed is:

1. An air-intake system for internal combustion engine, the air-intake system comprising:
an inter cooler;
a first intake air passage arranged on an upstream side of the inter cooler;
a second intake air passage arranged on a downstream side of the inter cooler;
a bypass passage that makes a detour around the inter cooler by connecting the first intake air passage and the second intake air passage with each other; and
a mounting seat for an intake air temperature sensor arranged on a confluence part of the second intake air passage and the bypass passage, a position of the mounting seat in an axis direction of the second intake air passage at least partially overlaping a position of the bypass passage in the axis direction of the second intake air passage.

2. The air-intake system according to claim 1 further comprising
a cylindrical part provided in the confluence part, wherein
the cylindrical part projects outwardly from the second intake air passage, and is thus fitted into a downstream end part of the bypass passage, and
an external dimension of the cylindrical part is set to be equal to or smaller than an external dimension of the mounting seat.

3. The air-intake system according to claim 2, wherein
a central line of an end part of the cylindrical part coincides with an axis of the mounting seat.

4. The air-intake system according to claim 3, wherein
the cylindrical part projects to an inner side of the second intake air passage, and the end part of the cylindrical part on the inner side of the second intake air passage is positioned on the intake air temperature sensor side beyond the axis of the second intake air passage.

5. The air-intake system according to claim 2, wherein
a plurality of bypass passages are provided in parallel to each other.

6. The air-intake system according to claim 2, wherein
both the cylindrical part and the mounting seat are positioned on an upper half side of a transverse section of the second intake air passage.

7. An air-intake system for an internal combustion engine, air-intake system comprising:
an inter cooler;
a first intake air passage arranged on an upstream side of the inter cooler;
a second intake air passage arranged on a downstream side of the inter cooler;
a bypass passage that makes a detour around the inter cooler by connecting the first intake air passage and the second intake air passage with each other;
a cylindrical part configured to connect the second intake air passage and the bypass passage with each other; and
a mounting seat for an intake air temperature sensor, the mounting seat being provided in the second intake air passage, and the mounting seat being arranged on a same circumference of the second intake air passage with the cylindrical part in the second intake air passage.

8. The air-intake system according to claim 7, wherein
the cylindrical part projects outwardly from the second intake air passage, the cylindrical part is configured to be fitted into a downstream end part of the bypass passage, and
an external dimension of the cylindrical part is set to be equal to or smaller than an external dimension of the mounting seat.

9. The air-intake system according to claim 8, wherein
a central line of an end part of the cylindrical part is arranged so as to coincide with an axis of the mounting seat.

10. The air-intake system according to claim 9, wherein
the cylindrical part projects to an inner side of the second intake air passage, and the end part of the cylindrical part on the inner side of the second intake air passage is positioned on the intake air temperature sensor side beyond an axis of the second intake air passage, and
the end part of the cylindrical part on the inner side of the second intake air passage faces the intake air temperature sensor at a given interval.

11. The air-intake system according to claim 8, wherein
a plurality of bypass passages are provided in parallel to each other.

12. The air-intake system according to claim 8, wherein
both the cylindrical part and the mounting seat are positioned on an upper half side of the second intake air passage.
